(19) United States
(12) Patent Application Publication
(10) Pub. No.: US 2026/0232039 A1
(43) Pub. Date: Aug. 13, 2026

(54) Aerosol Generation Device and Method

(71) Applicant: JT International SA, Geneva (CH)

(72) Inventor: Claude Zominy, Copponex (FR)

(73) Assignee: JT International SA, Geneva (CH)

(21) Appl. No.: 19/155,759

(22) PCT Filed: Mar. 27, 2024
(86) PCT No.: PCT/EP2024/058264

§ 371 Date: Aug. 12, 2025

(30) Foreign Application Priority Data
Mar. 28, 2023 (EP) 23164704.1

(51) Int. Cl. A24F 40/57; A24F 40/60; H02J 7/00; H02J 7/80; H02J 7/90

(52) U.S. Cl. CPC A24F 40/57; A24F 40/60; H02J 7/80; H02J 7/855; H02J 7/933

(57) ABSTRACT

According to the present disclosure there is provided an aerosol generation device comprising one or more electrical components comprising an aerosol generator component, wherein the aerosol generation device is selectively configurable in: an aerosol generation mode in which aerosol for inhalation by a user is generated by provision of electrical power from the battery cell to the aerosol generator component; and a discharge mode based on a discharge input, thereby to cause discharging of a battery cell of the aerosol generation device, wherein the battery cell is configured to provide electrical power to one or more of the one or more electrical components.

### BACKGROUND

The present disclosure relates to an aerosol generation device. The present disclosure further relates to a method.

Battery cell recycling is a recycling activity that aims to reduce the number of battery cells being disposed alongside regular household waste. Battery cells contain heavy metals and toxic chemicals and disposing of them by the same process as regular household waste has raised concerns over soil contamination and water pollution. Furthermore, battery cell recycling can help to prevent a future shortage of battery cell materials and to enable a sustainable life cycle of these technologies.

An aerosol generation device is configured to heat an aerosol substrate to generate aerosol for inhalation. An aerosol generation device includes a power supply in the form of a battery cell. The battery cell provides power for operation of the aerosol generation device, and for example may provide the necessary power to generate aerosol. It may be desirable to access the battery cell, for replacement and/or recycling.

Existing techniques do not allow for access to and removal of the battery cell in a safe manner. Dangers associated with extraction of the battery cell include electrical, chemical, and thermal dangers, and their potential interactions.

It is the object of the invention to overcome at least some of the above referenced problems.

### SUMMARY

According to the present disclosure there is provided an aerosol generation device and method, including the features as set out in the claims.

According to a first aspect of the present invention, there is provided an aerosol generation device comprising: one or more electrical components comprising an aerosol generator component, wherein the aerosol generation device is selectively configurable in: an aerosol generation mode in which aerosol for inhalation by a user is generated by provision of electrical power from the battery cell to the aerosol generator component; and a discharge mode based on a discharge input, thereby to cause discharging of a battery cell of the aerosol generation device, wherein the battery cell is configured to provide electrical power to one or more of the one or more electrical components.

By such a construction, the battery cell of the aerosol generation device can be discharged (in other words, selectively and deliberately discharged). This is highly advantageous in improving safety in a disassembly or recycling process, which may be performed by a disassembler (i.e., a person performing disassembly of the aerosol generation device or a part thereof, who may otherwise be referred to as an “operator”). The present construction enables battery cell discharging without exposure to, or handling of, a charged battery cell by the disassembler. Furthermore, risks to the disassembler due to thermal runaway of the battery cell are mitigated, as the disassembler need not handle or be exposed to a charged battery cell.

The discharge mode may cause the deliberate or intentional discharging of the battery cell. That is, the purpose, aim or function of the discharge mode is to discharge the battery cell. This is in contrast to an aerosol generation mode, in which the purpose, aim or function is the generation of aerosol. This is also in contrast to cleaning or maintenance modes, in which the purpose, aim or function is to clean or maintain components of the aerosol generation device. For example, a cleaning or maintenance mode may comprise the performance of a “burn-off” of residuals at components of the aerosol generation device.

The discharge input may be a specific input to cause or initiate discharging of the battery cell. This is in contrast to inputs to cause or initiate the generation of aerosol, which whilst discharging the battery cell, is not a discharge input but rather an aerosol generation input or command. In general, the discharge input is any input that causes the aerosol generation device to enter the discharge mode, or is used to commence or perform the discharge mode. The discharge input may be, for example a button press or sequence of button presses to cause the device to enter the discharge mode, or in a further example may be by connection of an external device, or a remote input or instruction. Similarly, the discharge mode may be a specific mode in which discharging of the battery cell is performed. This is in contrast to modes in which the aerosol generation device is able to, or awaits inputs to, generate aerosol. Such modes are not discharge modes, as it is not an intention or focus of said modes to discharge the battery cell.

Furthermore, it will be appreciated that selective configuration of the aerosol generation device may mean that the aerosol generation device is configurable in two distinct modes (e.g., at different times, and/or when commanded by a user, operator or disassembler). This is in contrast with conventional devices. Conventional devices typically operate to generate aerosol (which corresponds with the present aerosol generation mode), and during such operation a battery cell may discharge due to provision of electrical power. However, conventional devices do not provide a further (potentially distinct, or separate) discharge mode, the aim of which is to facilitate battery cell discharging. In contrast with conventional devices, the device described herein provides two modes, one of aerosol generation (possibly as conventional) and also a specific discharge mode.

In one example, in the aerosol generation mode, the aerosol generation device is configured to provide an aerosol output (e.g., a non-zero aerosol output); and in the discharge mode, the aerosol generation device is configured to provide an aerosol output that is lower than the aerosol output in the aerosol generation mode and/or no aerosol output.

Such an example is highly advantageous. In this way, the battery cell may thereby be discharged in a safe and controlled manner, and convenience for the disassembler is improved. Lower or no aerosol output may correspond with use of reduced temperatures or electrical currents during discharging, which has numerous associated advantages. Operation at a reduced temperature reduces risk of overheating and/or reduced risk of damage to the aerosol generation device or battery cell. Prolonged discharging periods, or an extended discharging mode, may be enabled. Furthermore, no aerosol output may correspond with use of a discharge device, which may allow higher electrical currents to be used, thereby facilitating more rapid discharging. Additionally, no aerosol output may correspond with a situation wherein no consumable is provided, thereby avoiding risk of overheating, burning or charring a consumable within the device.

Furthermore, if any aerosol output is provided in the discharge mode, then the output may be lower than the aerosol output in the aerosol generation mode. It is clear that if aerosol is generated in the discharge mode, it is not for inhalation by the user, and this may be indicated to the user and/or understood by the user. Lower aerosol output may be due to the aerosol generation device being provided with a depleted, or partially depleted, consumable, or alternatively due to the discharging component (e.g., heater component) being operated such that the aerosol output is comparatively lower, for example by provision of a relatively reduced electrical current, and/or by operating at a relatively lower temperature compared with an aerosol generation mode temperature. Additionally, no aerosol output may be generated in instances where an aerosol generator component is operated at a temperature lower than a temperature sufficient for the consumable to generate aerosol. Furthermore, no aerosol output may be generated in instances where electrical power is provided from the battery cell to a discharge device (e.g., comprising a resistive load).

In one example, in the discharge mode the aerosol generation device is configured to: sense the presence or absence of a consumable at the aerosol generation device; and based on sensing the absence of a consumable, provide electrical power from the battery cell to the aerosol generator component.

This approach is again distinct from conventional operation of an aerosol generation device to generate aerosol, which ultimately results in discharging of a battery cell. In the present example, it is sensed that the device is not provided with a consumable (e.g., no consumable is inserted into the device). The discharge mode may then operate to provide electrical power to the aerosol generator component, and no aerosol output provided due to the absence of a consumable. This is advantageous as it avoids potential overheating risk, or other issues, which may occur with prolonged exposure of a consumable to heating during the discharge mode. One or more sensors may be provided for said sensing.

In one example, the provision of electrical power from the battery cell to the aerosol generator component is controlled so that the aerosol generator component operates at a temperature below an aerosol generation mode temperature.

An aerosol generation mode temperature may be a temperature of an aerosol generation mode during which aerosol is generated for inhalation by a user. For example, this may exclude a pre-heating phase or a cool down phase. The aerosol generation mode temperature may be a temperature, or range of temperatures, at which the heater is operated to enable the generation of aerosol for inhalation by a user. The aerosol generation mode temperature may be relatively consistent compared with temperatures exhibited during heat-up or cool-down phases. The aerosol generator component being controlled to operate at a temperature below the aerosol generation mode temperature is advantageous as this approach facilitates use of the aerosol generator component for discharge, whilst reducing risk of overheating and/or reduced risk of damage to the aerosol generation device or battery cell. Prolonged discharging periods, or an extended discharging mode, is thereby enabled.

Relatedly, an aerosol generation mode aerosol level (which may include an amount, or quality, or composition) may be a level (e.g. an output level) of an aerosol during which aerosol is suitable for inhalation by a user (which may include an amount, or quality, or composition). For example, this may exclude a pre-heating phase, and additionally also may exclude a cool down phase. The level of aerosol in the aerosol generation mode may be a level, or range of levels, at which the heater is operated to enable the generation of aerosol for inhalation by a user. The level of aerosol in the aerosol generation mode may be relatively consistent compared with levels or amounts possible during heat-up or cool-down phases. The aerosol generator component being controlled to operate at an aerosol generation level below the aerosol generation mode level is advantageous as this approach facilitates use of the aerosol generator component for discharge, whilst reducing risk of overheating and/or reduced risk of damage to the aerosol generation device or battery cell. Prolonged discharging periods, or an extended discharging mode, is thereby enabled.

In one example, the aerosol generation device is connectable to a discharge device, and in the discharge mode the aerosol generation device is configured to provide electrical power from the battery cell to the discharge device.

A discharge device will be described in further detail herein. However, in relation to this feature, performing a discharge mode in which electrical power is provided to the discharge device is highly advantageous as, in an example, a separate, but connectable, device can be used to facilitate discharging of the battery cell. That is, for example, discharging is thereby enabled in instances where a consumable comprising an aerosol generator component is not provided, and furthermore, the discharge device may enable more rapid discharging than that allowed by discharging through an aerosol generator component or other component of the aerosol generation device. For example, safety may be improved by discharging using a dedicated discharge device, and in some examples the allowed discharging current may be higher due to provision of the discharging device, as compared with the (e.g., safe) levels of discharging possible using the aerosol generation device.

In one example, the aerosol generation device further comprises an interface for displaying information related to the discharge mode, and wherein: the interface is configured to output an indication of the aerosol generation device being configured in the discharge mode.

The interface will be described in further detail below. Briefly, in this way, the interface may indicate to the user or disassembler that the discharge mode is being performed. Advantageously, in an example where the discharging occurs via an aerosol generator component of a consumable, or when the aerosol generation device is provided with a consumable, the user or disassembler may thereby understand that any aerosol generated is due to the discharge mode, and is not aerosol for inhalation (e.g., compared with aerosol for inhalation which is generated during the aerosol generation mode). In other words, the indication of discharging of the battery cell may enable the user to establish that the aerosol generation device is in the discharge mode. The interface may indicate that the aerosol generation device is in the discharge mode. In this way, it will be appreciated from the description herein that if any aerosol is generated whilst the aerosol generation device is operating in the discharge mode, the user will be able to understand that the generated aerosol is not for inhalation (i.e., unlike that generated in an aerosol generation mode/that generated during an aerosol inhalation session). It will be understood that the generated aerosol during the discharging mode is only a result of the discharging.

In one example, the provision of electrical power from the battery cell to the one or more electrical components does not cause the generation of aerosol.

In one example, the provision of electrical power from the battery cell is to one or more dedicated, or specific, discharging components. Said components may be independent of an aerosol generation circuit. That is, provision of electrical power to said components may not result in the generation of aerosol. Provision of electrical power to said components may thereby draw energy from the battery cell without causing the generation of aerosol.

In this way, discharging of the battery cell may be simplified. Furthermore, the discharging of the battery cell may thus be less cumbersome, more practical or more convenient to the disassembler. Additionally, such a construction is particularly advantageous where an activation system of the aerosol generation device comprises a puff sensor, which requires air to be drawn through the aerosol generation device in order to activate the aerosol generation device to generate aerosol, as the requirement for activation of the puff sensor may be eliminated.

Furthermore, in this way, discharging of the aerosol generation device need not require the aerosol generation device to comprise, or be provided with, a consumable to be used to generate aerosol. Discharging without the generation of aerosol may also improve safety as the conditions employed for discharging the battery cell may comprise reduced power (e.g., reduced current, when compared with an aerosol generation mode) or lower temperatures than that used in aerosol generation.

In a related example, as described further herein, based on a discharge input being provided at the aerosol generation device, the aerosol generation device may establish whether a consumable is provided to the device (e.g., inserted in a heating chamber). If the device establishes that the device is not provided with a consumable (i.e., the device is absent a consumable), the device may then provide electrical power to one or more discharging components, for example to the heater component.

In one example, an aerosol generation current is required to cause the generation of aerosol using the aerosol generation device, and in the discharge mode a discharge current is provided to the one or more electrical components which is lower than the aerosol generation current and is insufficient to cause the generation of aerosol.

In this way, the aerosol generation device is operable to discharge without the generation of aerosol. In other words, the discharge mode is distinct from the discharge mode in that each mode achieves a different result by performing, or initiating, a different function (the discharging of the battery cell vs. the generation of aerosol).

In one example, in the aerosol generation mode, the aerosol generation device provides an aerosol output by aerosolizing/vaporizing a given portion/mass of consumable and in the discharge mode the aerosol generation device provides no aerosol output and/or an aerosol output than is significantly lower in term of portion/mass of consumable than in the aerosol generation mode.

The battery cell may thereby be discharged in a safe and controlled manner, and convenience for the disassembler is improved. Furthermore, the aerosol generation mode and discharge mode are thus distinct modes.

In one example, the provision of electrical power from the battery cell to the one or more electrical components is controlled based on one or more properties of the battery cell and/or the one or more electrical components.

In this way, safety of the discharging process may be improved. The one or more properties may be, or comprise, a charge level, for example a charge level of the battery cell, or a charge level of an energy storage (or other) device to which the battery cell is connected. Additionally or alternatively, the property may be a current or voltage level, for example of the battery cell, or of an energy storage (or other) device to which the battery cell is connected. Furthermore, the one or more properties may comprise a temperature, for example, a temperature of the battery cell and/or a temperature of the one or more electrical components. By controlling the provision of electrical power based on temperature, overheating can be prevented. Furthermore, by controlling the provision of electrical power based on charge level, the battery cell can be discharged at a safe or suitable rate, or to a charge level that is safe for a disassembler to subsequently handle the battery cell.

The provision of electrical power may be according to a profile. The profile may be adapted in real-time and incorporate feedback such that the profile is based on the one or more properties.

In one example, the provision of electrical power from the battery cell to the one or more electrical components is controlled to reduce the charge level of the battery cell to below a threshold charge level.

In this way, the battery cell may be discharged to reduce the charge level to a level that is safe for disassembler handling, and ultimately recycling of the battery cell. The threshold charge level may be a charge level in the range of 0% to 30%, preferably 30%.

In one example, the provision of electrical power from the battery cell to the one or more electrical components is controlled to reduce the battery charge level to below a minimum charge level limit of the aerosol generation device in an aerosol generation mode.

In this way, the battery cell can be discharged below a charge level that it is possible to obtain using an aerosol generation mode. An aerosol generation device may limit the minimum battery cell charge level in an aerosol generation mode, for reliability reasons. However, by the present construction, the battery cell can be discharged to below said minimum battery cell charge level in the aerosol generation mode, thus improving safety to the disassembler and reducing the risk of thermal runaways during handling of the battery cell during disassembly, servicing, or maintenance. This lower charge level of the battery cell can be obtained by using the discharge mode, whereas this lower charge level would not be obtainable simply using an aerosol generation mode.

In one example, the aerosol generation device comprises a processor configured to: configure the aerosol generation device in the discharge mode based on the discharge input.

In this way, the aerosol generation device may be configured in the discharge mode, and the discharge mode triggered or initiated by the discharge input. The discharge input may be a discharge instruction. A discharge instruction may be a specific action or command provided by a disassembler. The discharge instruction may be provided at the aerosol generation device, or may be provided by a remote (or external) device. Alternatively, the discharge input may be provided by a connection (e.g., the making of an electrical connection) to an external device.

In one example, the discharge input is provided by connection of a discharge device to the aerosol generation device.

A discharge device may be a device comprising one or more electrical components by which the battery cell of the aerosol generation device can be discharged. Connecting the discharge device to the aerosol generation device may provide the discharge input to configure the aerosol generation device in the discharge mode. In an example, it may be registered at the aerosol generation device that the discharge device has been connected and the aerosol generation device is configured in a discharge mode. Alternatively, it may not be registered at the aerosol generating device that the discharge device has been connected and the aerosol generation device is configured in a discharge mode and instead the discharge mode may simply be the discharging of the aerosol generating device by provision of electrical power to one or more electrical components of the discharge device via the connection therebetween.

In one example, the aerosol generation device is arranged to provide a direct electrical connection of the discharge device with the battery cell.

In this way, lifetime of aerosol generation device components may be improved. Furthermore, this may simplify construction of the aerosol generation device.

Direct electrical connection with the battery cell may be without the provision of intermediate componentry, such as one or more PCBs or any other components.

In one example, the discharge device may be provided as a housing portion of the aerosol generation device. The discharge device may be provided to replace a removable housing portion of the aerosol generation device. When connected to the aerosol generation device, the discharge device may thereby form a part of a housing (e.g., outer casing, or cover) of the aerosol generation device.

The discharge device may be formed integrally with said housing portion. That is, the housing portion may be, or provide, a discharge device. In this way, the housing portion is electrically connectable to the aerosol generation device to facilitate discharging of the battery cell. In such an example, an existing housing portion of the aerosol generation device could be removed, and replaced with the housing portion comprising the discharge device. The housing portion may be electrically connected to the aerosol generation device, thereby to discharge the battery cell. Advantageously, such a construction enables discharging of the battery cell, whilst ensuring that components of the aerosol generation device are still protected (i.e., user access prevented) as the discharge device provides a housing portion to complete a housing (e.g., outer casing or cover) of the aerosol generation device.

In one example, the one or more electrical components comprises: an aerosol generator component and/or a resistive load. The aerosol generator component may comprise a heater component (which may comprise a resistive load that generates heat by the joule effect). The aerosol generator component may alternatively be a nebulizer or induction heater component. The aerosol generator component may otherwise be referred to as an aerosol engine, or vapour generating unit (VGU).

In this way, discharging of the battery cell may be performed by provision of electrical power from the battery cell to an aerosol generator component and/or to a resistive load. The aerosol generator component and/or resistive load may be provided in the aerosol generation device and/or in a discharge device. Preferably the aerosol generator component is an aerosol generator component provided in the aerosol generation device. For example, the aerosol generator component may be an oven or heater, nebulizer, or induction heater component, of the aerosol generating device. Advantageously, in this way, discharging of the battery cell can thereby be performed using existing componentry of the aerosol generating device, but performed using the specific discharge mode.

In one example, the one or more electrical components comprises the aerosol generator component, and the provision of electrical power from the battery cell to the aerosol generator component is controlled so that the aerosol generator component operates at a temperature below an aerosol generation temperature, for example a temperature of below 180° C.

In this way, the battery cell can be discharged without the generation of aerosol, which may improve convenience or practicality to the disassembler. Furthermore, advantageously, controlling the electrical power in this manner improves as the risk of device overheating is reduced. Discharging in this way is possible with or without a consumable present (i.e., received in the aerosol generating device). The operation temperature of the aerosol generator component may be substantially constant during the discharge mode or may be varied over time according to a heating profile. In an advantageous example, a heating profile may be employed wherein a target temperature is obtained followed by a pause in heating. This heating profile may be repeated one or more times according to a cycle or sequence. Safety is thus improved, as it is ensured that the aerosol generator component does not exceed a safe operating temperature. Furthermore, it is ensured that other componentry of the aerosol generating device can be reused and are not damaged during the discharge mode.

In one example, the one or more electrical components comprises the aerosol generator component, and the provision of electrical power from the battery cell to the aerosol generator component is controlled so that the aerosol generator component operates at a temperature in the range of 30 to 160° C., for example 60° C.

Such temperatures advantageously ensure a balance of discharge mode time and disassembler safety due to exposure to component heating, whilst also ensuring reusability of components by mitigating damage thereto.

In one example, the aerosol generation device further comprises an interface (as introduced above) for displaying information related to the discharge mode.

In this way, the disassembler can be informed that the battery cell is discharging, or has been discharged, such that the battery cell can be accessed and handled in a safe manner.

In one example, the interface is configured to provide an indication of discharging of the battery cell and/or an indication of a charge level of the battery cell. In this way, the disassembler may establish that the battery cell is discharged or discharging.

The interface may comprise an element configured to change or alter a characteristic thereof depending of the charge level of the battery cell. For example, the element may comprise chemicals which change colour depending on charge level of the battery cell.

Moreover, the interface may display information relating to temperature of one or more components, for example temperature of an aerosol generator component or of a resistive load. In this way, the disassembler can establish that the battery cell is substantially discharged due to a low heating temperature of the aerosol generator component or resistive load.

In one example, the aerosol generation device is configured to: generate or receive the discharge input based on an input at the aerosol generation device; and/or receive the discharge input from a remote device. The input may be provided by a disassembler.

In this way, the disassembler may trigger or initiate a specific discharge mode by providing an input at the aerosol generation device. Alternatively, or additionally, the disassembler may command a discharge mode of the aerosol generation device from a remote device, such as a smartphone.

In one example, the discharge mode is distinct from an aerosol generation mode.

The discharge mode and aerosol generation mode may be separate modes which are individually selectable. Each mode has a different aim or desired function-in the discharge mode the aim is to discharge the battery cell, whereas in the aerosol generation mode the aim is to generate aerosol or be in a state whereby aerosol may be generated. No interaction with the disassembler, or other user of the device, may be required when the aerosol generation device is in the discharge mode. Enabling or configuring the discharge mode may require confirmation from the disassembler in order to enter the discharge mode. The discharge mode and aerosol generation mode may have different characteristics, for example different minimum charge level parameters, different electrical power parameters, and/or different temperature parameters or profiles.

Whilst some residual aerosol may be generated in the discharge mode, such aerosol is not for inhalation, and can be indicated as such, or understood as such, by the disassembler, for example through the interface, or by understanding of the device operation and configuration in the discharge mode.

In one example, the processor is configured to configure the aerosol generation device in the discharge mode by switching from an aerosol generation mode to the discharge mode, based on the discharge input, which may be a discharge instruction.

This is highly advantageous in a disassembly and recycling process, as the disassembler can configure the aerosol generating device in the specific mode for discharging the battery cell.

According to a second aspect of the present invention, there is provided a method of controlling an aerosol generation device comprising: one or more electrical components comprising an aerosol generator component, wherein the aerosol generation device is selectively configurable in: an aerosol generation mode in which aerosol for inhalation by a user is generated by provision of electrical power from the battery cell to the aerosol generator component; and a discharge mode based on a discharge input, thereby to cause discharging of a battery cell of the aerosol generation device by the provision of electrical power from the battery cell to one or more of the one or more electrical components, the method comprising: configuring the aerosol generation device in the discharge mode based on the discharge input, thereby to cause discharging of a battery cell of the aerosol generation device by the provision of electrical power from the battery cell to one or more of the one or more electrical components.

The second aspect of the present invention may incorporate any or all of the features of the first aspect of the present invention, as desired or as appropriate.

In one example, in the aerosol generation mode, the aerosol generation device is configured to provide an aerosol output; and in the discharge mode, the aerosol generation device is configured to provide an aerosol output that is lower than the aerosol output in the aerosol generation mode and/or no aerosol output, the method comprising: configuring the aerosol generation device in the discharge mode to provide an aerosol output that is lower than the aerosol output in the aerosol generation mode and/or no aerosol output.

In one example, the method comprises, in the discharge mode, outputting an indication of the aerosol generation device being configured in the discharge mode using an interface.

According to a third aspect of the present invention, there is provided a discharge device for connection to an aerosol generation device according to the first aspect of the present invention, the discharge device being arranged to provide the discharge input to the aerosol generation device.

The discharge input may be, or comprise, connection of (or connecting) the discharge device to the aerosol generation device. The discharge input may be a discharge instruction provided from the discharge device to the aerosol generation device.

The discharge device may comprise one or more electrical components. The discharge device may be connectable to an aerosol generation device configurable in a discharge mode based on a discharge input, thereby to cause discharging of a battery cell of the aerosol generation device by the provision of electrical power from the battery cell to the one or more electrical components.

The third aspect of the present invention may incorporate any or all of the features of the above aspects of the present invention, as desired or as appropriate.

According to a fourth aspect of the present invention, there is provided an aerosol generation device comprising: a processor configured to: configure the aerosol generation device in a discharge mode based on a discharge input; and cause electrical power to be provided from a battery cell of the aerosol generation device to one or more electrical components of the aerosol generation device to discharge the battery cell.

The fourth aspect of the present invention may incorporate any or all of the features of the above aspects of the present invention, as desired or as appropriate.

According to a fifth aspect of the present invention, there is provided a discharge device for connection to a battery cell of an aerosol generating device, the discharge device comprising: one or more electrical components connectable to one or more contacts in direct electrical connection with the battery cell, thereby to discharge the battery cell.

The fifth aspect of the present invention may incorporate any or all of the features of the above aspects of the present invention, as desired or as appropriate.

### BRIEF DESCRIPTION OF THE DRAWINGS

Examples of the present disclosure will now be described with reference to the accompanying drawings.

FIG. 1 shows an aerosol generation device;

FIG. 2 shows an aerosol generation device and a discharge device;

FIG. 3 shows general methodology principles; and

FIG. 4 shows an aerosol generation device.

### DETAILED DESCRIPTION

As used herein, the term “aerosol precursor material”, “vapour precursor material” or “vaporizable material” are used synonymously and may refer to a material and/or composition, which may for example comprise nicotine or tobacco and a vaporising agent. The aerosol precursor material is configured to release an aerosol when heated or otherwise mechanically stimulated (such as by vibrations). Tobacco may take the form of various materials such as shredded tobacco, granulated tobacco, tobacco leaf and/or reconstituted tobacco. Nicotine may be in the form of nicotine salts. Suitable vaporising agents include: a polyol such as sorbitol, glycerol, and glycols like propylene glycol or triethylene glycol; a non-polyol such as monohydric alcohols, acids such as lactic acid, glycerol derivatives, esters such as triacetin, triethylene glycol diacetate, triethyl citrate, glycerin or vegetable glycerin. In some examples, the aerosol precursor material is substantially a liquid that holds or comprises one or more solid particles, such as tobacco. An aerosol generation device is configured to aerosolise an aerosol precursor material without combustion in order to facilitate delivery of an aerosol to a user. Furthermore, and as is common in the technical field, the terms “vapour” and “aerosol”, and related terms such as “vaporize”, “volatilize” and “aerosolise”, may generally be used interchangeably.

As used herein, the term “aerosol generation device” is synonymous with “aerosol generating device” or “device” may include a device configured to heat an aerosol precursor material and deliver an aerosol to a user. The device may be portable. “Portable” may refer to the device being for use when held by a user or disassembler. The device may be adapted to generate a variable amount of aerosol, which can be controlled by a user input.

As used herein, the term “aerosol” may include a suspension of vaporizable material as one or more of: solid particles; liquid droplets; gas. Said suspension may be in a gas including air. Aerosol herein may generally refer to/include a vapour. Aerosol may include one or more components of the vaporizable material.

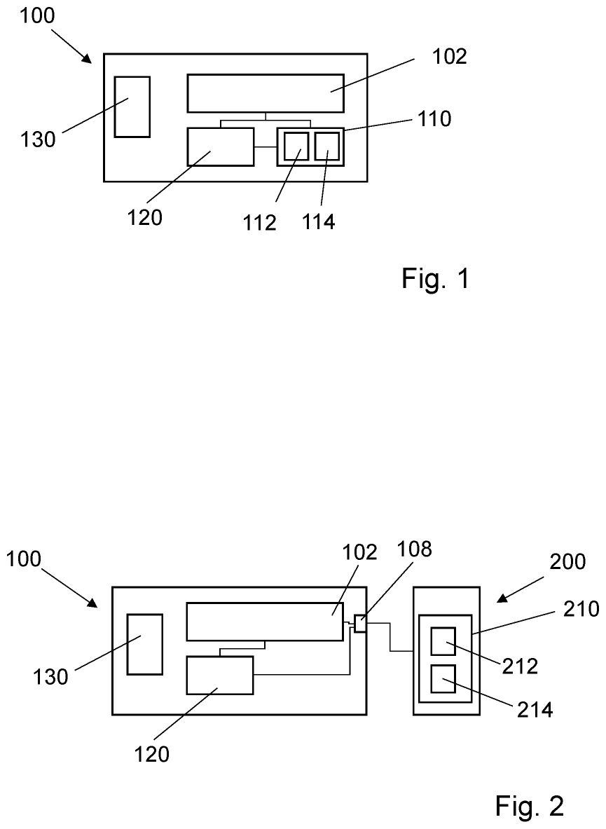

Referring to FIGS. 1 and 2, an aerosol generation device 100 is shown. The aerosol generation device 100 is configurable in a (deliberate, selective) discharge mode. The aerosol generation device 100 is configurable in a discharge mode based on (e.g., in response to) a discharge input. The aerosol generation device 100 is configurable in the discharge mode based on the discharge input thereby to cause discharging of a battery cell 102 of the aerosol generation device 100 by the provision of electrical power from the battery cell 102 to one or more electrical components 110, 210.

As described in greater detail below, the one or more electrical components 110, 210 comprise an aerosol generator component 112, 212. The aerosol generation device 100 is selectively configurable in an aerosol generation mode and the discharge mode. In the aerosol generation mode, aerosol for inhalation by a user is generated by provision of electrical power from the battery cell 102 to the aerosol generator component 112, 212. In contrast, in the discharge mode, discharging of the battery cell 102 is caused, and the battery cell 102 is configured to provide electrical power to one or more of the one or more electrical components 110, 210.

It should be understood that this is in contrast to conventional devices, which are operable to provide an aerosol generation mode, but are not also configurable in a deliberate, selective, and/or dedicated discharge mode for discharging the battery cell 102.

As shown in FIG. 1, in a first embodiment, the one or more electrical components are provided in the aerosol generation device 100. The one or more electrical components are indicated at reference numeral 110. That is, the one or more electrical components 110 may be component parts of (e.g., integral to) the aerosol generation device 100.

However, as shown in FIG. 2, in a second embodiment, the one or more electrical components are not provided in the aerosol generation device 100. Instead, the one or more electrical components are provided in a discharge device 200. The one or more electrical components are indicated at reference numeral 210. That is, the one or more electrical components 210 may be component parts of (e.g., integral to) an external device in the form of a discharge device 200. The discharge device 200 may be arranged to provide the discharge input to the aerosol generation device 100.

It will be appreciated from the description provided herein that the first and second embodiments may be combined. In particular, the aerosol generation device 100 may provide one or more electrical components 110 and the discharge device 200 may provide one or more electrical components 210. Discharging of the battery cell 102 may be performed by the provision of electrical power from the battery cell 102 to the one or more electrical components 110 of the aerosol generation device 100 and/or to the one or more electrical components 210 of the discharge device 200. That is, the aerosol generation device 100 may be configurable to perform discharging through the one or more electrical components 110 of the aerosol generation device 100 and/or to the one or more electrical components 210 of the discharge device 200. This may depend on whether a discharge device 200 is connected, an input, and/or a particular discharge mode. Discharging through the one or more electrical components 110 of the aerosol generation device 100 and to the one or more electrical components 210 of the discharge device 200 may occur simultaneously or at different times.

In other words, the discharge mode is a mode of the aerosol generation device in which deliberate or intentional discharging of the battery cell occurs. That is, the function of the discharge mode is to discharge the battery cell. During the discharge mode, electrical power is provided from the battery cell 102 to one or more electrical components 110, 210 to facilitate discharging of the battery cell 102. The discharge mode may be initiated or incorporated into a disassembly or recycling process for the aerosol generation device 100.

The current drawn from the battery cell 102 during the discharge mode may be lower than the current drawn from the battery cell 102 during the aerosol generation mode. In this way, the battery cell 102 can be discharged in a safe and controlled manner, and risk of overheating can be mitigated.

In an example, the discharge input is a specific input to cause or initiate discharging of the battery cell 102. In response to the discharge input, the aerosol generation device 100 may be configured in the discharge mode. Confirmation may be required in order to configure the aerosol generation device 100 in the discharge mode. Once the aerosol generation device 100 is configured in the discharge mode, further input or interaction need not be required in order to perform discharging of the battery cell 102. Discharging of the battery cell 102 may continue until a threshold charge level of the battery cell 102 is obtained, at which point discharging may be terminated. This is in contrast to the aerosol generation mode, where electrical power is only provided when the user interacts with the aerosol generation device (for example, by puffing on the aerosol generation device 100 thereby activating a puff sensor or the like) or when a consumable comprising aerosol substrate is inserted and stays present in the aerosol generation device 100.

As a general summary, the aerosol generation device 100 is configurable in a discharge mode to deliberately discharge the battery cell 102 so that the battery cell 102 can be safely accessed by a disassembler for recycling of the battery cell 102, without exposing the disassembler to a charged battery cell 102 or requiring the disassembler to handle a charged battery cell 102. This differs to the usual aerosol generation mode of the aerosol generation device 100 as the discharge mode enables a lower charge level of the battery cell 102 to be achieved, with the primary consideration being discharging of the battery cell 102 rather than the generation of aerosol. That is, the primary aim of the discharge mode is to discharge the battery cell 102. Subsequent to discharging of the battery cell 102, the battery cell 102 may be safely removed from the aerosol generation device 100 for disposal or recycling. The aerosol generation device 100 may be provided with a new battery cell—that is, replacement of the battery cell is facilitated.

In an example, the provision of electrical power from the battery cell 102 to the one or more electrical components 110, 210 does not cause the generation of aerosol.

That is, electrical power from the battery cell 102 may be providable to the one or more electrical components 110, 210 such that the power provided to the one or more electrical components 110, 210 does not result in the generation of aerosol. This may involve providing the electrical power to components other than those which are arranged to heat a consumable so as to generate aerosol, or providing the electrical power to components which are arranged to heat a consumable at a level (e.g., a power level) which is insufficient for the generation of aerosol. In an example, the electrical power provided to such components may be at a low enough level such that temperatures suitable to generate aerosol are not obtained. Discharging the battery cell 102 without the generation of aerosol is highly advantageous in improving the lifetime of aerosol generating components of the aerosol generation device 100 and improving convenience and practicality of the recycling process.

In other examples, aerosol may be generated during discharging of the battery cell in the discharge mode, but may be at a level which is lower than that generated during an aerosol generation mode of the aerosol generating device. Furthermore, aerosol may be generated during discharging of the battery cell in the discharge mode without activation of an activation system of the aerosol generation device, for example via puff sensors (or other sensors indicating use by a user).

As described elsewhere in the description, if any aerosol is generated during discharging of the battery cell in the discharge mode, it can be indicated to the user, or to a disassembler, that the aerosol is not generated during the aerosol generation mode, and is not for inhalation. The aerosol generated during the discharge mode may be known as “residual aerosol” and may be due to operation of a heater component heating a consumable during the discharging.

In other words, related to the above, in the aerosol generation mode, the aerosol generation device is configured to provide an aerosol output; and in the discharge mode, the aerosol generation device is configured to provide an aerosol output that is lower than the aerosol output in the aerosol generation mode and/or no aerosol output. A lower aerosol output may mean a comparatively lower aerosol generation rate (e.g., amount per unit time) compared with the aerosol generation mode.

In some examples, sensors which sense the presence of a consumable, or sense the level of the consumable may be disabled during the discharge mode, or the information provided by such sensors may not be used. That is, the discharge mode may be operable in absence of a consumable or where the consumable level is low or zero. This is in contrast to an aerosol generation mode, which may only be initiated if a consumable is present or detected, or if the consumable level is sufficient to generate aerosol.

In a related example, sensors which sense the presence of the consumable may be enabled to facilitate commencement, or performance, of the discharge mode. Based on a received discharge input, the aerosol generation device 100 may establish whether the aerosol generation device 100 is provided with a consumable, and only provide electrical power from the battery cell 102 to the one or more electrical components 110, 210 when it is established that the aerosol generation device 100 is not provided with a consumable.

In further detail, in the discharge mode the aerosol generation device 100 is configured to: sense the presence or absence of a consumable at the aerosol generation device; and based on sensing the absence of a consumable, provide electrical power from the battery cell 102 to the aerosol generator component 112, 212.

As introduced above, the current drawn from the battery cell 102 during the discharge mode may be lower than the current drawn from the battery cell 102 during the aerosol generation mode. The current drawn from the battery cell 102 during the aerosol generation mode may be an aerosol generation current (i.e., a current sufficient to generate aerosol, by heating of a consumable) whereas the current drawn from the battery cell 102 during the discharge mode may be a discharge current which is lower than the aerosol generation current (i.e., a current insufficient to generate aerosol, as a sufficient temperature cannot be reached by a aerosol generator component). This may facilitate safe and controlled discharging of the battery cell 102.

In a related example described further herein, the current drawn from the battery cell 102 during the discharge mode may be a discharge current which is sufficient to generate aerosol when provided to a heater component, but an interface (e.g., interface 130) may indicate that aerosol generation device 100 is being operated in a discharge mode (and thus the aerosol is generated in a discharge mode). The user may then understand that the generated aerosol is not for inhalation. The generated aerosol may be a comparatively low level of aerosol generation, for example due to use of an at least partially, or largely, depleted consumable, or due to a comparatively lower temperature or electrical current that that employed during the aerosol generation mode.

In an example, in the aerosol generation mode, the aerosol generation device 100 provides an aerosol output (e.g., a non-zero aerosol output) and in the discharge mode the aerosol generation device 100 provides an aerosol output than is lower than the aerosol output in the aerosol generation mode and/or no aerosol output.

This is highly advantageous, as the aerosol generation device 100 can thereby be configurable in two distinct modes of operation, including an aerosol generation mode in which aerosol is provided for inhalation, and a discharging mode for discharging the battery cell 102 which may involve the generation of some level of aerosol but understood by the user not to be for inhalation, for example due to an indication provided by the interface 130 described herein. The battery cell may thereby be discharged in a safe and controlled manner, and convenience for the disassembler is improved.

In other words, in the aerosol generation mode, the aerosol generation device 100 provides an aerosol output by aerosolizing/vaporizing a given portion/mass of consumable and in the discharge mode the aerosol generation device 100 provides no aerosol output and/or an aerosol output than is significantly lower in term of portion/mass of consumable than in the aerosol generation mode.

The battery cell 102 may thereby be discharged in a safe and controlled manner, and convenience for the disassembler is improved. Furthermore, the aerosol generation mode and discharge mode are thus distinct modes.

In an example, the provision of electrical power from the battery cell 102 to the one or more electrical components 110, 210 is controlled based on one or more properties of the battery cell 102 and/or the one or more electrical components 110, 210.

The provision of power may be controlled by a processor of the aerosol generation device 100, as discussed in greater detail below. Additionally, or alternatively, the provision of power may be controlled by a discharge device 200. Additionally, or alternatively, the provision of power may be controlled by a remote device, such as a smartphone.

The one or more properties may be, or comprise, a charge level, for example a charge level of the battery cell, or a charge level of an energy storage device to which the battery cell is connected. Voltage and current levels may also be useful properties. Furthermore, the one or more properties may comprise a temperature, for example, a temperature of the battery cell and/or a temperature of the one or more electrical components. By controlling the provision of electrical power based on temperature, overheating can be prevented. Furthermore, by controlling the provision of electrical power based on charge level, the battery cell can be discharged at a safe or suitable rate, or to a charge level that is safe for a disassembler to subsequently handle the battery cell.

In an example, the provision of electrical power from the battery cell 102 to the one or more electrical components 110, 210 is controlled to reduce the charge level of the battery cell 102 to below a threshold charge level.

A threshold charge level may be a charge level at which it is determined the battery cell 102 presents a low risk to the disassembler or operator handling the battery cell 102. The threshold charge level may be a charge level of 30% of the maximum battery cell charge level (i.e., maximum charge capacity). The threshold charge level may be a threshold charge level in the discharge mode. The threshold charge level may not be obtainable in an aerosol generation mode, or other mode of normal operation of the device 100.

In some examples, reaching the threshold charge level may terminate the discharge mode. In other examples, a battery protection mode may automatically disconnect the battery cell when the voltage reaches a threshold level (for example 2.5 V), or a processor of the aerosol generation device 100 (e.g., processor 120 described above) may be programmed to terminate operation of the aerosol generation device 100 when the voltage of the battery cell 102 falls below a threshold level (for example 3 V). In this way, the discharge mode may be terminated without monitoring the battery charge level in the discharge mode, which may simplify the discharge mode.

In an example, the provision of electrical power from the battery cell 102 to the one or more electrical components 110, 210 is controlled to reduce the battery charge level to below a minimum charge level limit of the aerosol generation device 100 in an aerosol generation mode.

That is, in an aerosol generation mode, a minimum charge level limit may be set or controlled in the aerosol generation device 100 which is the minimum charge level of the battery cell 102 that can be obtained in the aerosol generation mode. Further battery cell charge depletion beyond this limit may be prevented, to ensure reliability of the battery cell. However, in the discharge mode, the battery cell 102 may be discharged to a charge level which is lower than the minimum charge level of the battery cell 102 that can be obtained in the aerosol generation mode. This is advantageous in improving disassembler safety. The charge level may be a voltage of the battery cell 102.

In an example, the aerosol generation device 100 comprises a processor 120 configured to configure the aerosol generation device in the discharge mode based on the discharge input.

The processor 120 may process the discharge input to configure the aerosol generation device 100 in the discharge mode. The processor 120 may configure the aerosol generation device 100 in the discharge mode. The processor 120 may configure the aerosol generation device 100 in the discharge mode by initiating or controlling the provision of electrical power from the battery cell 102 to the one or more electrical components 110, 210.

The discharge input may be a discharge instruction. The discharge instruction may be provided at the aerosol generation device, or may be provided by a remote (or external) device. Alternatively, the discharge input may be provided by a connection (e.g., the making of an electrical connection) to an external device.

In an example, the discharge input is provided by connection of discharge device 200 to the aerosol generation device 100. More generally, the discharge device 200 may be arranged to provide the discharge input to the aerosol generation device 100.

The connection of the discharge device 200 to the aerosol generation device 100 may be a physical connection or may be a wireless connection (e.g., a wireless connection with wireless power transfer functionality).

The one or more electrical components 210 of the discharge device 200 may enable discharging of the battery cell 102 by provision of electrical power to the one or more electrical components 210. For example, the one or more electrical components 210 may comprise a resistive load (e.g., a resistor or arrangement of resistors) and/or aerosol generator components (e.g., an oven or heater, or nebulizer, or induction heater component). The discharge device 200 may be configured to be provided with electrical power to be dissipated as heat, or to be provided with electrical power for storage at the discharge device 200 (e.g., in a battery cell thereof). The function of the discharge device 200 is to discharge the battery cell 102 of the aerosol generation device 100, for example by receiving electrical power from the battery cell 102 of the aerosol generation device 100 and/or drawing electrical power from the battery cell 102 of the aerosol generation device 100.

Connecting the discharge device 200 to the aerosol generation device 100 may provide the discharge input to configure the aerosol generation device 100 in the discharge mode. In an example, it may be registered at the aerosol generation device 100 that the discharge device 200 has been connected and the aerosol generation device is configured in a discharge mode. Alternatively, it may not be registered at the aerosol generating device 100 that the discharge device 200 has been connected and the aerosol generation device 100 is configured in a discharge mode and instead the discharge mode may simply be the discharging of the aerosol generating device 100 by provision of electrical power to one or more electrical components 210 of the discharge device 200 via the connection therebetween.

Additionally, or alternatively, the discharge input from the discharge device 200 may be a discharge instruction. The discharge instruction may be provided to the processor 120 of the aerosol generation device 100. The discharge instruction may be provided to configure the aerosol generation device 100 in the discharge mode to commence discharging via the discharge device 200.

As will be understood from the description herein, the aerosol generation device 100 may be connectable to the discharge device 200, and in the discharge mode the aerosol generation device 100 is configured to provide electrical power from the battery cell 102 to the discharge device 200.

In an example, the discharge device 200 may be provided as a housing portion of the aerosol generation device 100. The discharge device 200 may be provided to replace a removable housing portion of the aerosol generation device 100. When connected to the aerosol generation device 100, the discharge device 200 may thereby form a part of a housing (e.g., outer casing, or cover) of the aerosol generation device 100.

The discharge device 200 may be formed integrally with said housing portion. That is, the housing portion may be, or provide, the discharge device 200. In this way, the housing portion is electrically connectable to the aerosol generation device 100 to facilitate discharging of the battery cell 102. In such an example, an existing housing portion of the aerosol generation device 100 could be removed, and replaced with the housing portion comprising the discharge device 200. The housing portion may be electrically connected to the aerosol generation device 100, thereby to discharge the battery cell 102. Advantageously, such a construction enables discharging of the battery cell 102, whilst ensuring that components of the aerosol generation device (particularly the battery cell 102) are still protected (i.e., user access prevented) as the discharge device provides a housing portion to complete a housing (e.g., outer casing or cover) of the aerosol generation device 100.

In an example, the aerosol generation device 100 is arranged to provide a direct electrical connection of the discharge device 200 with the battery cell 102.

Direct electrical connection may mean that electrical connection is formed without intermediate componentry, such as one or more printed circuit boards (PCBs). That is, the point of electrical connection may not be, for example, a charging point or connection of the aerosol generating device 100, which provide charging power to the battery cell 102 via a PCB of the aerosol generating device 100. Instead, the electrical connection is direct to the battery cell 102, thus bypassing any PCBs of the aerosol generating device 100.

The direct electrical connection may be provided by connection elements in direct contact or connection with the battery cell 102. The connection may be made via one or more contacts 108 which are in electrical connection with the battery cell 102. The contacts 108 may be covered during normal use and when the discharge device 200 is not connected. This may advantageously reduce risk of short circuit. The contacts 108 may be exposed, to become accessible for making a connection using the discharge device 200. The contacts 108 may exposed by removing one or more covers or capping elements. The one or more covers or capping elements may be removable, for example may be removably mounted to prevent access to the contacts 108. Removing the one or more covers or capping elements may facilitate connection of the discharge device 200 with the battery cell 102.

The direct electrical connection may mean that the connection is via a discharge circuit which is configured to enable discharging of the battery cell 102. The discharge circuit may comprise the battery cell 102, connection elements, and contacts 108. Other components may be provided, such as one or more PCBs or protection elements (e.g., fuses). However, these components do not form part of a charging circuit. The discharge circuit may passively or actively manage the discharge of the battery cell 102. The discharge circuit may bypass or avoid use of one or more components of the aerosol generation device 100, for example one or more components of a charging circuit.

It will be appreciated that the one or more contacts 108 may be distinct from charging contacts of the aerosol generation device 100. Examples of conventional aerosol generation devices comprise contacts with which an electrical connection can be made to charge a battery cell thereof. However, the contacts 108 are not charging contacts, and are instead contacts specifically utilised for discharging the battery cell.

The one or more covers or capping elements may be destructible. The term “destructible” is used to refer to the nature of the one or more covers or capping elements. The term “destructible” is used to refer to one or more covers or capping elements which are configured (e.g., deliberately configured) to be at least partially destructible, for example to lose or degrade one or more of its mechanical properties or its mechanical integrity (for example hardness or mechanical strength) by appropriate processing. Processing might typically include the application of heat or a liquid, such as a water-based solution or a solvent, to the one or more covers or capping elements. This configuration (e.g., deliberate configuration) may be achieved by the choice of material or materials used to form the destructible one or more covers or capping elements. However, the influence of the heat or liquid does not necessarily cause the complete destruction of the one or more covers or capping elements. Instead, the one or more covers or capping elements may be formed of a destructible material such that the application of heat or a solvent degrades the mechanical properties or integrity of the material. For example, the one or more covers or capping elements may soften or weaken, such that they are more easily or readily cut, teared, sheared or broken. That is, the mechanical properties or integrity may be degraded such that it is easier to cut, tear, shear or break the one or more covers or capping elements (i.e., in general, easier to access the contacts 108), compared with a time prior to processing (e.g., the application of heat or solvent).

Other components of the aerosol generation device 100 may be non-destructible components. That is, unlike the destructible covers or capping elements which are deliberately configured to be destructed, the other components are not deliberately configured to be destructed. The other components may destruct at a significantly lesser rate, or not at all, under the same conditions to which the destructible covers or capping elements are exposed. For example, the one or more other components of the aerosol generation device 100 may not dissolve or be destructed in a solvent, whilst the destructible covers or capping elements will dissolve or be destructed in the same solvent.

In a highly advantageous example, the one or more covers or capping elements are dissolvable. The one or more covers or capping elements may be dissolvable in a water-based solution or in a solvent, or due to application of a water or solvent to the one or more covers or capping elements. As with the discussion of the term “destructible”, the one or more covers or capping elements may completely or partially dissolve. Partial dissolution may mean that a constituent part of the one or more covers or capping elements is dissolved, allowing that part to be more easily removed or manipulated, or for a remaining part of the one or more covers or capping elements to be removed, for example peeled away. Dissolving the one or more covers or capping elements may comprise immersing the aerosol generation device 100 or a part thereof in water or in a solvent.

In an example, the one or more covers or capping elements may be formed of fibres (such as natural fibres or glass fibres) and a bonding agent used to bond the fibres to form one or more covers or capping elements having a strong mechanical resistance. The bonding agent may be dissolvable, thereby degrading the mechanical properties of the material. The fibres may then be pierced, peeled away, or otherwise removed. Access to the contacts 108 is thereby facilitated.

The destruction of the one or more covers or capping elements may occur at room temperature, for example in a solvent at room temperature. Alternatively, the destruction of the one or more covers or capping elements may occur by application of heat or a solvent at a temperature of between 50° C. and 90° C., and preferably between 70° C. and 90° C.

In an example, the one or more electrical components 110, 210 comprises an aerosol generator component 112, 212 and/or a resistive load 114, 214.

The aerosol generator component 112, 212 may be an oven, heater, nebulizer, or induction heater component. The aerosol generator component 112, 212 may be a heat dissipation component or element. The resistive load 114, 214 may be a resistor or any other load through which energy may be dissipated by the provision of electrical power to the resistive load 114, 214. The aerosol generator component 112, 212 and/or resistive load 114, 214 may be provided with a protection element, such as an insulating cover, to protect a disassembler from contact with the heated component.

The oven may be provided in the aerosol generation device 100. The heater may be provided in the aerosol generation device 100, or may be incorporated in a consumable (for example in a pod or cartridge to be received in the aerosol generation device 100). The heater being provided in the aerosol generation device 100 is advantageous in enabling the discharge mode, or discharging of the battery cell 102, even in situations where the aerosol generation device 100 is not provided with a consumable.

Provision of electrical power to the aerosol generator component 112, 212 causes discharging of the battery cell 102. However, this differs to the standard heating cycle of the aerosol generation device 100 in an aerosol generation mode. In an aerosol generation mode, electrical power may be provided to the aerosol generator component to generate aerosol for consumption by a user. In the aerosol generation mode, electrical power may be provided cyclically, or according to a profile, to optimally produce aerosol. The aerosol generation mode may provide heating in order to deliver a predefined aerosol dose, or provide heating for a fixed duration to deliver a constant dose during a puff performed by the user. However, in the discharge mode, electrical power may be provided to the aerosol generator component 112, 212 continuously, thereby to produce continuous heating using the aerosol generator component 112, 212. In the discharge mode, no consumable need be present, and no aerosol need be generated, in order to discharge the battery cell 102. Electrical power may be provided to the aerosol generator component 112, 212 and/or resistive load 114, 214 until the threshold charge level is reached.

As described at length elsewhere herein, it will be appreciated that the discharge mode could also be performed with a consumable present, and a non-zero level of aerosol output being provided, but it can be indicated to the user that the aerosol generation device is operating in a discharge mode. This allows the user to establish that the aerosol is not for inhalation.

In an example, the one or more electrical components 110, 210 comprises the aerosol generator component 112, 212, and the provision of electrical power from the battery cell 102 to the aerosol generator component 112, 212 is controlled so that the aerosol generator component operates at a temperature below an aerosol generation temperature, for example a temperature of below 180° C.

This is possible in the discharge mode as it is not the function of the discharge mode to generate aerosol. Instead, it is an aim to discharge the battery cell 102 in a safe and controlled manner. The aerosol generation temperature may be a boiling point of one or more chemicals comprised in the consumable. The boiling point of a liquid-based consumable may be 188° C. to 190° C., and so maintaining a temperature of 180° C. ensures that aerosol is not generated during the discharge mode.

The processor 120 of the aerosol generation device 100 and/or the discharge device 200 may control said provision of electrical power.

In another example, the provision of electrical power may be controlled so that the aerosol generator component operates at an aerosol generation temperature intermittently (e.g., at a temperature otherwise employed in an aerosol generation mode). A heating profile may be employed to cause heating to an aerosol generation temperature, followed by heating to a reduced temperature, and this may be repeated one or more times. Such a profile reduces risk of overheating.

In an example, the one or more electrical components comprises the aerosol generator component, and the provision of electrical power from the battery cell to the aerosol generator component is controlled so that the aerosol generator component operates at a temperature in the range of 30 to 160° C., for example 60° C.

The processor 120 of the aerosol generation device 100 and/or the discharge device 200 may control said provision of electrical power.

Operating the aerosol generator component in this temperature range ensures discharge of the battery cell 102 in a safe and controlled manner, whilst minimising the risk of overheating of components of the aerosol generation device 100 and/or the discharge device 200.

In an example, the aerosol generation device 100 further comprises an interface 130 for displaying information related to the discharge mode.

The interface 130 may indicate that the aerosol generation device 100 is in the discharge mode, or is configured in a discharging state, or is performing a discharging function or cycle. That is, the interface 130 may provide information to inform the disassembler that the battery cell 102 is being discharged. The interface 130 is configured to output an indication of the aerosol generation device 100 being configured in the discharge mode. Additionally, the interface 130 may provide information to inform the disassembler of the charge level of the battery cell 102. The interface 130 may provide an indication to the disassembler when the charge level of the battery cell 102 reaches, or has fallen below, the threshold charge level. In this way, the disassembler can establish that the battery cell 102 is safe to handle or remove from the aerosol generation device 100.

In an example, the interface 130 is configured to provide an indication of discharging of the battery cell and/or an indication of a charge level of the battery cell. In this way, the disassembler may establish from the information provided by the interface 130 that the battery cell 102 is discharged or discharging.

The indication of the discharge mode (or, similarly, that the device is configured in a discharging state, or is performing a discharging function or cycle) may allow the user to understand that any aerosol being generated is not for inhalation whilst the device 100 is in the discharge mode. This is distinct from an aerosol generation mode, or during an aerosol inhalation session, where the user understands that the generated aerosol is for inhalation.

The interface 130 may comprise an element configured to change or alter a characteristic thereof depending of the charge level of the battery cell 102. For example, the element may comprise chemicals which change colour depending on charge level of the battery cell 102.

Moreover, the interface 130 may display information relating to temperature of one or more components 110, 210, for example temperature of an aerosol generator component 112, 212 or of a resistive load 114, 214. In this way, the disassembler can establish that the battery cell 102 is substantially discharged due to a low heating temperature of the aerosol generator component 112, 212 or resistive load 114, 214, for example when the battery cell 102 provides insufficient electrical power to cause high temperature heating.

The interface 130 may comprise a display, screen, or the like. The interface 130 may comprise an arrangement of one or more LEDs, which are lit (e.g., in a particular colour) to indicate that the aerosol generation device 100 is configured in the discharge mode.

In an example, the aerosol generation device 100 is configured to: generate or receive the discharge input based on an input at the aerosol generation device 100; and/or receive the discharge input from a remote device.

The disassembler may provide the input at the aerosol generation device 100, as the discharge input, to enter the aerosol generation device 100 into the discharge mode. The input may be a button press, or a series of button presses. Alternatively, or additionally, the disassembler may command a discharge mode of the aerosol generation device 100 from a remote device, such as a smartphone.

In an example, the discharge mode is distinct from an aerosol generation mode.

The discharge mode and aerosol generation mode may be separate modes which are individually selectable. Each mode has a different aim or desired function-in the discharge mode the aim is to discharge the battery cell 102, whereas in the aerosol generation mode the aim is to generate aerosol or be in a state whereby aerosol may be generated. No interaction with the disassembler may be required when the aerosol generation device 100 is in the discharge mode. Enabling or configuring the discharge mode may require confirmation from the disassembler. The discharge mode and aerosol generation mode may have different characteristics, for example different minimum charge level parameters, different electrical power parameters, and/or different temperature parameters or profiles.

In an example, the processor 120 is configured to configure the aerosol generation device 100 in the discharge mode by switching from an aerosol generation mode to the discharge mode, based on the discharge input, which may be a discharge instruction.

This is highly advantageous in a disassembly and recycling process, as the disassembler can configure the aerosol generating device 100 in the specific mode for discharging the battery cell.

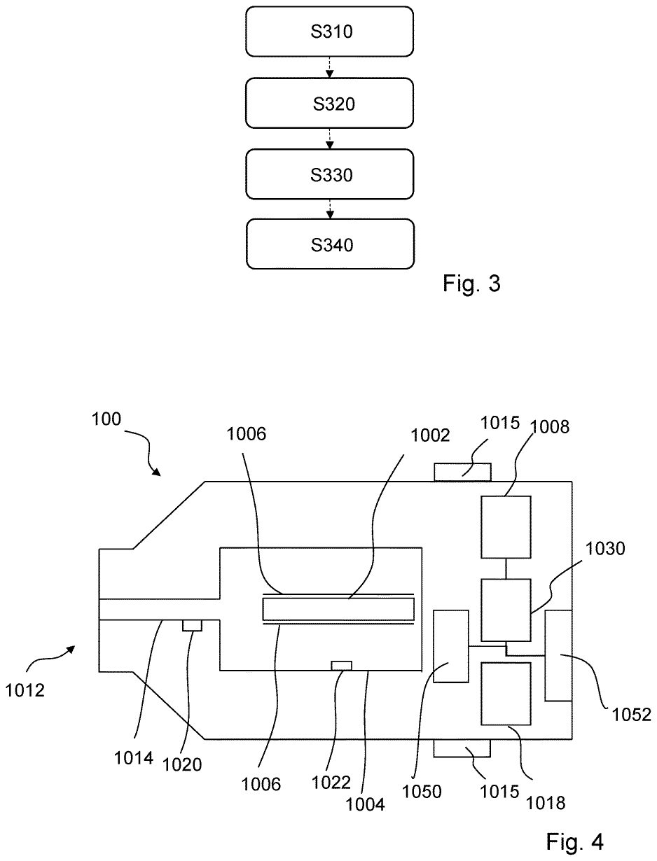

Referring to FIG. 3, a method of controlling an aerosol generation device is shown. The aerosol generation device comprises comprising: one or more electrical components comprising an aerosol generator component, wherein the aerosol generation device is selectively configurable in: an aerosol generation mode in which aerosol for inhalation by a user is generated by provision of electrical power from the battery cell to the aerosol generator component; and a discharge mode based on a discharge input, thereby to cause discharging of a battery cell of the aerosol generation device, wherein the battery cell is configured to provide electrical power to one or more of the one or more electrical components. Step S310 comprises configuring the aerosol generation device in the discharge mode based on the discharge input, thereby to cause discharging of a battery cell of the aerosol generation device by the provision of electrical power from the battery cell to one or more of the one or more electrical components.

The method may comprise any or all of the features described above in relation to FIGS. 1 and 2, as desired or as appropriate.

In the aerosol generation mode, the aerosol generation device is configured to provide an aerosol output (e.g. suitable for inhalation by a user); and in the discharge mode, the aerosol generation device is configured to provide an aerosol output that is lower than the aerosol output in the aerosol generation mode and/or no aerosol output. Optional Step S320 comprises configuring the aerosol generation device in the discharge mode to provide an aerosol output that is lower than the aerosol output in the aerosol generation mode and/or no aerosol output.

Optional Step S330 comprises, in the discharge mode, outputting an indication of the aerosol generation device being configured in the discharge mode using an interface.

A further optional Step comprises disconnecting the battery cell from the aerosol generation device subsequent to discharging. A further optional Step comprises removing the battery cell from the aerosol generation device subsequent to discharging. A further optional Step comprises providing the aerosol generation device with a new battery cell subsequent to removal of the battery cell from the aerosol generation device. That is, said optional step comprises replacing the discharged battery cell with a new battery cell. A further optional step comprises recycling the removed battery cell.

Referring to FIG. 4, a schematic cross-sectional view of an aerosol generation device 100 is shown.

The aerosol generation device 100 may be according to the first and/or second embodiment described above.

The aerosol generation device 100 is suitable for receiving a consumable 1002 therein. For example, the aerosol generation device 100 may include a chamber 1004 in which the consumable 1002 is received.

The invention is not limited to the specific aerosol generation device 100 or consumable 1002 described herein. That is, the description of the aerosol generation device 100 and consumable 1002 is provided for illustrative purposes only. The skilled person will appreciate that alternative constructions of aerosol generation devices and consumables will be compatible with the present invention.

A consumable 1002 comprises an aerosol substrate. The term aerosol substrate is a label used to mean a medium that generates an aerosol or vapour when heated. Aerosol substrate might be interpreted as an aerosol precursor. In one example, aerosol substrate is synonymous with smokable material, aerosol generation substrate and aerosol generation medium. Aerosol substrate includes materials that provide volatilized components upon heating, typically in the form of vapor or an aerosol. Aerosol substrate may be a non-tobacco-containing material or a tobacco-containing material. Aerosol substrate may, for example, include one or more of tobacco per se, tobacco derivatives, expanded tobacco, reconstituted tobacco, tobacco extract, homogenized tobacco or tobacco substitutes. Aerosol substrate also may include other, non-tobacco, products, which, depending on the product, may or may not contain nicotine. Aerosol substrate may comprise one or more humectants, such as glycerol or propylene glycol.

The aerosol generation device 100 may comprise one or more heaters 1006 configured to provide heat to the consumable 1002, in use.

In one example, the consumable 1002 contains a liquid and the one or more heaters comprises a heating element, such as a coil, a ceramic heater, a flat resistive heater, a mesh heater, a MEMS heater, or the like, configured to aerosolise the liquid for inhalation. A liquid delivery element or mechanism, such as a porous material, a capillary system, and/or valve, may transfer the liquid to the heating element, in use. In some examples, the aerosolised liquid may pass through a solid substrate within the aerosol generation device 100. In other examples, the consumable 1002 may comprise a solid aerosol substrate.

In one example, the aerosol generation device 100 comprises a nebulizing engine, such as a vibrating mesh, to generate an aerosol from a liquid with or without heating thereof.

The aerosol generation device 100 may comprise a mouthpiece 1012 through which a user draws on the aerosol generation device 100 to inhale generated aerosol. The mouthpiece 1012 includes a vent or channel 1014 that is connected to a region close to the consumable 1002 for passage of any generated aerosol from the consumable 1002, during use. For example, the channel 1014 may extend between an opening in the mouthpiece 1012 and the chamber 1004 in which the consumable 1002 is at least partially receivable. The mouthpiece 1012 is arranged such it may be received in a user's mouth in use. In other examples, a mouthpiece 1012 is not required and a portion of the consumable 1002 may protrude from the aerosol generation device 100. In this example, protruded portion of the consumable 1002 may work as mouthpiece.

The aerosol generation device 100 may comprise a control unit 1008 (or control circuitry) for electronic management of the device. The control unit 1008 may include a PCB or the like (not shown). The control unit 1008 is configured to control the one or more heaters 1006.

The aerosol generation device 100 may comprise an activation input sensor 1018. The activation input sensor 1018 may be a button, a touchpad, or the like for sensing a user's input, such as a tap or swipe. In other examples, the activation input sensor 1018 comprises a consumable sensor configured to detect if a consumable 1002 has been inserted into the aerosol generation device 100. For example, the input sensor 1018 may comprise an authenticity detector that is configured to detect if an authentic consumable 1002 has been inserted into the aerosol generation device 100. Additionally, or alternatively, the user input may also comprise an inhalation action by a user.

The aerosol generation device 100 may comprise a puff sensor 1020 (otherwise known as an inhalation sensor). The puff sensor 1020 is configured to detect an inhalation action (or puff) by a user on the aerosol generation device 100. In one example, the puff sensor 1020 comprises a microphone or a flow sensor configured to an airflow within the chamber 1004 and/or an airflow channel extending from the chamber 1004 through the mouthpiece 1012 to an inhalation outlet thereof, the airflow being associated with a user's inhalation action. In other examples, the puff sensor 1020 is configured to detect a change in pressure indicative of a beginning of an inhalation action on the aerosol generation device 100 by the user. In this case, the puff sensor 1020 may be located anywhere on the aerosol device 100 in which there would be a change in pressure due to an inhalation action of the user. In one example, the puff sensor 1020 is located in the channel 1014 between the chamber 1004 and the mouthpiece 1012 of the aerosol generation device 100. The puff sensor 1020 may also detect the end of an inhalation action by the user. For example, the puff sensor 1020 may be configured to detect a further change in pressure due to the end of an inhalation action of a user.

The aerosol generation device 100 may include one or more temperature sensors 1022 configured to directly or indirectly measure the temperature of the consumable 1002 in the aerosol generation device 100. The one or more temperature sensors 1022 may comprise a temperature sensor, such as a thermocouple or thermistor, configured to be located within or adjacent to the consumable 1002 when it is received in the aerosol generation device 100. For example, the one or more temperature sensors 1022 may be located within the chamber 1004 of the aerosol generation device 100. In other examples, the temperature of the consumable 1002 may be indirectly measured by the use of thermal imaging sensors. In further other example, the heater 1006 itself works as a temperature sensor if the heater 1006 has PTC (Positive Temperature Coefficient) or NTC (Negative Temperature Coefficient) characteristic.

The aerosol generation device 100 may include a power supply 1050 such as a battery cell. The power supply 1050 may be the battery cell 102 described above. The power supply 1050 may comprise, or be, a battery module. The power supply may provide the aerosol generation device 100 with electrical energy providing a voltage in the range of 3 V and 18 V, preferably in the range of 3 V and 4.2 V. In a preferred embodiment the voltage source (which may be the battery cell 102) is a lithium-ion secondary battery delivering a value of 3.6-3.7 V. Such a voltage source is particularly advantageous for a modern aerosol generation device in view of rechargeability, high energy density and large capacity. The power supply 1050 may provide power for operation of the aerosol generation device 100, for example the necessary power to generate aerosol. In an example, the power supply 1050 may provide power to one or more heaters 1006.

The aerosol generation device 100 may comprise a controller or processor 1030. The processor 1030 is connected to the control unit 1008. The processor 1030 is configured to receive data from the control unit 1008. In particular, the processor 1030 is configured to receive data from the control unit 1008 relating to various sensors/inputs (such as the activation input sensor 1018, puff sensor 1020 and/or temperature sensor 1022) of the aerosol generation device 100.

The processor 1030 may be configured to configure the aerosol generation device 100 in the discharge mode based on a discharge input in the form of a discharge instruction. The processor 1030 may be configured to cause electrical power to be provided from the battery cell 102, 1050 to one or more electrical components (such as one or more heaters 1006) to discharge the battery cell 102, 1050.

In another example, a discharge input may be provided by way of electrical contacts of the aerosol generation device 100, for example using a dedicated discharge device as discussed herein.

The processor 1030 and the control unit 1008 may be integral with each other. In one example, a single component performs the function of the control unit 1008 and processor 1030. In other examples, the control unit 1008 and the processor 1030 are distinct components.

The aerosol generation device 100 may comprise a USB port 1052 (e.g., a USB receiving port). The USB port may provide connection to the controller 1030.

It will be appreciated that the invention that has been described and defined above may allow the related apparatus and methods to drive, comply with, or more easily comply with, legal and regulatory requirements, guidelines and standards. In particular, this might be in relation to one or more of apparatus (e.g. battery or related device) inspection, indication/status, recycling, reuse, repair, replacement, and maintenance, whether by an end user or service provider.

Referring generally to the description herein, further detail is hereby provided in relation to terms used above and features described in the present disclosure, or to further terms relevant to the present disclosure:
A “battery” may mean any device delivering electrical energy generated by direct conversion of chemical energy, having internal or external storage, and consisting of one or more non-rechargeable or rechargeable battery cells or modules thereof, and includes a battery that has been subject to preparation for re-use, preparation for repurposing, repurposing or remanufacturing;
A “battery module” may mean one or more battery module components (e.g., any set of one or more battery cells and/or one or more other components, as described above) that are connected together or encapsulated within an outer casing, housing, surround, envelope, wrapping, or the like, to protect the cells against internal impact, and which is meant to be used either alone or in combination with other modules. In some examples, a “battery module” within the context of this specification may otherwise be known as a “battery pack”;
A “battery cell” may mean the basic functional unit in a battery, composed of electrodes, electrolyte, container, terminals, and, if applicable, separators, and containing the active materials the reaction of which generates electrical energy;
An “active material” means a material which reacts chemically to produce electric energy when the battery cell discharges or to store electric energy when the battery is being charged.

Although preferred embodiments have been shown and described, it will be appreciated by those skilled in the art that various changes and modifications might be made without departing from the scope of the invention, as defined in the appended claims and as described herein.

Examples of the invention, or examples related to the invention, may be further or alternatively defined or described as follows:

1. An aerosol generation device configurable in a discharge mode based on a discharge input, thereby to cause discharging of a battery cell of the aerosol generation device by the provision of electrical power from the battery cell to one or more electrical components.

2. An aerosol generation device according to example 1, wherein the provision of electrical power from the battery cell to the one or more electrical components does not cause the generation of aerosol.

3. An aerosol generation device according to example 1 or 2, wherein the provision of electrical power from the battery cell to the one or more electrical components is controlled based on one or more properties of the battery cell and/or the one or more electrical components.

4. The aerosol generation device according to example 3, wherein the provision of electrical power from the battery cell to the one or more electrical components is controlled to reduce the charge level of the battery cell to below a threshold charge level.

5. The aerosol generation device according to example 3 or example 4, wherein the provision of electrical power from the battery cell to the one or more electrical components is controlled to reduce the battery charge level to below a minimum charge level limit of the aerosol generation device in an aerosol generation mode.

6. The aerosol generation device according to any one of the preceding examples, the aerosol generation device comprising:
a processor configured to:
   configure the aerosol generation device in the discharge mode based on the discharge input.

7. The aerosol generation device according to any one of the preceding examples, wherein the discharge input is provided by connection of a discharge device to the aerosol generation device.

8. The aerosol generation device according to example 7, wherein the aerosol generation device is arranged to provide a direct electrical connection of the discharge device with the battery cell.

9. The aerosol generation device according to any one of the preceding examples, wherein the one or more electrical components comprises: an aerosol generator component and/or a resistive load.

10. The aerosol generation device according to example 9, wherein the one or more electrical components comprises the aerosol generator component, and wherein the provision of electrical power from the battery cell to the aerosol generator component is controlled so that the aerosol generator component operates at a temperature below an aerosol generation temperature, for example a temperature of below 180° C.

11. The aerosol generation device according to example 10, wherein the one or more electrical components comprises the aerosol generator component, and wherein the provision of electrical power from the battery cell to the aerosol generator component is controlled so that the aerosol generator component operates at a temperature in the range of 30 to 160° C., for example 60° C.

12. The aerosol generation device according to any one of the preceding examples, further comprising an interface for displaying information related to the discharge mode.

13. The aerosol generation device according to any one of the preceding examples, wherein the aerosol generation device is configured to:
generate or receive the discharge input based on an input at the aerosol generation device; and/or
receive the discharge input from a remote device.

14. A discharge device for connection to an aerosol generation device according to any one of the preceding examples, the discharge device being arranged to provide the discharge input to the aerosol generation device.

15. A method of controlling an aerosol generation device, comprising:
configuring the aerosol generation device in a discharge mode based on a discharge input, thereby to cause discharging of a battery cell of the aerosol generation device by the provision of electrical power from the battery cell to one or more electrical components.

1. An aerosol generation device comprising:
one or more electrical components comprising an aerosol generator component,
wherein the aerosol generation device is selectively configurable between:
an aerosol generation mode in which aerosol for inhalation by a user is generated by provision of electrical power from a battery cell to the aerosol generator component; and
a discharge mode based on a discharge input, thereby causing discharging of a battery cell of the aerosol generation device, wherein the battery cell is configured to provide electrical power to one or more of the one or more electrical components.

2. The aerosol generation device according to claim 1, wherein:
in the aerosol generation mode, the aerosol generation device is configured to provide an aerosol output; and
in the discharge mode, the aerosol generation device is configured to provide an aerosol output that is lower than the aerosol output in the aerosol generation mode and/or no aerosol output.

3. The aerosol generation device according to claim 1, wherein:
in the discharge mode the aerosol generation device is configured to:
sense the presence or absence of a consumable at the aerosol generation device; and
based on sensing the absence of a consumable, provide electrical power from the battery cell to the aerosol generator component.

4. The aerosol generation device according to claim 1, wherein the provision of electrical power from the battery cell to the aerosol generator component is controlled so that the aerosol generator component operates at a temperature below an aerosol generation mode temperature.

5. The aerosol generation device according to claim 1, wherein the aerosol generation device is connectable to a discharge device, and in the discharge mode the aerosol generation device is configured to provide electrical power from the battery cell to the discharge device.

6. The aerosol generation device according to claim 1, further comprising:
an interface for displaying information related to the discharge mode, and wherein:
the interface is configured to output an indication of the aerosol generation device being configured in the discharge mode.

7. An aerosol generation device according to claim 1, wherein the provision of electrical power from the battery cell to the one or more electrical components is controlled based on one or more properties of the battery cell and/or the one or more electrical components.

8. The aerosol generation device according to claim 7, wherein the provision of electrical power from the battery cell to the one or more electrical components is controlled to reduce the charge level of the battery cell to below a threshold charge level.

9. The aerosol generation device according to claim 7, wherein the provision of electrical power from the battery cell to the one or more electrical components is controlled to reduce the battery charge level to below a minimum charge level limit of the aerosol generation device in an aerosol generation mode.

10. The aerosol generation device according to claim 1, the aerosol generation device comprising:
a processor configured to:
configure the aerosol generation device in the discharge mode based on the discharge input.

11. The aerosol generation device according to claim 1, wherein the aerosol generation device is configured to:
generate or receive the discharge input based on an input at the aerosol generation device; and/or
receive the discharge input from a remote device.

12. A discharge device for connection to an aerosol generation device according to claim 1, the discharge device being arranged to provide the discharge input to the aerosol generation device.

13. A method of controlling an aerosol generation device comprising: one or more electrical components comprising an aerosol generator component, the method comprising:
configuring the aerosol generation device in an aerosol generation mode in which aerosol for inhalation by a user is generated by provision of electrical power from a battery cell to the aerosol generator component;
configuring the aerosol generation device in a discharge mode based on a discharge input, thereby causing discharging of the battery cell of the aerosol generation device by the provision of electrical power from the battery cell to one or more of the one or more electrical components.

14. The method according to claim 13, further comprising:
configuring the aerosol generation device in the discharge mode to provide an aerosol output that is lower than the aerosol output in the aerosol generation mode and/or no aerosol output.

15. The method according to claim 13, or further comprising:
in the discharge mode, outputting an indication of the aerosol generation device being configured in the discharge mode using an interface.
